(19) United States
(12) Patent Application Publication
(10) Pub. No.: US 2018/0136642 A1
(43) Pub. Date: May 17, 2018

(54) Control method, control device and control system for unmanned aerial vehicle

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 15/854,784

(22) Filed: Dec. 27, 2017

(30) Foreign Application Priority Data
Dec. 30, 2016 (CN) 201611257085.7

(51) Int. Cl. G05D 1/00; G05D 1/08; B64C 39/02; G02B 27/01

(52) U.S. Cl. CPC G05D 1/0016; G05D 1/0808; G05D 1/0044; G02B 2027/0178; G02B 27/017; B64C 2201/146; B64C 2201/127; B64C 39/024

(57) ABSTRACT

A control method, a control device and a control system for an unmanned aerial vehicle are provided. The control method includes steps of: receiving sensor data from a head-mounted electronic device; according to the sensor data, generating a control instruction for controlling a carrier device of the unmanned aerial vehicle; and sending the control instruction to the unmanned aerial vehicle. The control method is able to increase a communication distance between the head-mounted electronic device and the unmanned aerial vehicle, decrease a cost and a weight of the head-mounted electronic device and increase application scenes of the head-mounted electronic device in a field of unmanned aerial vehicle control.

### CROSS REFERENCE OF RELATED APPLICATION

The application claims priority under 35 U.S.C. 119(a-d) to CN 201611257085.7, filed Dec. 30, 2016.

### BACKGROUND OF THE PRESENT INVENTION

### Field of Invention

The present invention relates to a field of air vehicle control, and more particularly to a control method, a control device and a control system for an unmanned aerial vehicle.

### Description of Related Arts

In recent years, the unmanned aerial vehicle (such as the fixed wing aircraft, including the rotor aircraft of helicopter and multi-rotor aircraft) has been widely applied in various fields (such as the detection field, and the research and rescue field). The control of the unmanned aerial vehicle is generally realized by a user through the remote control device.

The virtual reality (VR) technology is a computer simulation system which is able to create and experience the virtual world. The VR technology utilizes the computer to generate a simulation environment which is an interactive system simulation of the three-dimensional dynamic vision and the entity behavior based on the multi-source information fusion, and the user is immersed in the simulation environment. The combination of the VR technology and the unmanned aerial vehicle brings the great improvement to the control technology of the unmanned aerial vehicle. For example, the combination of the VR glasses and the unmanned aerial vehicle brings the new visual experience way to the user.

### SUMMARY OF THE PRESENT INVENTION

An object of the present invention is to provide a control method, a control device and a control system for an unmanned aerial vehicle.

A control method for an unmanned aerial vehicle comprises steps of: receiving sensor data from a head-mounted electronic device; according to the sensor data, generating a control instruction for controlling a carrier device of the unmanned aerial vehicle; and sending the control instruction to the unmanned aerial vehicle.

A control device for an unmanned aerial vehicle comprises:

a data receiving unit, for receiving sensor data from a head-mounted electronic device;

an instruction generating unit, for generating a control instruction for controlling a carrier device of the unmanned aerial vehicle according to the sensor data; and

an instruction sending unit, for sending the control instruction to the unmanned aerial vehicle.

A control system for an unmanned aerial vehicle comprises a head-mounted electronic device, a remote control device and the unmanned aerial vehicle, wherein: the head-mounted electronic device sends generated sensor data to the remote control device; the remote control device generates a control instruction for controlling a carrier device of the unmanned aerial vehicle according to the received sensor data, and then sends the control instruction to the unmanned aerial vehicle; and the unmanned aerial vehicle adjusts the carrier device according to the received control instruction to form an attitude corresponding to the control instruction.

The control method, the control device and the control system for the unmanned aerial vehicle provided by the present invention are able to increase a communication distance between the head-mounted electronic device and the unmanned aerial vehicle, decrease a cost and a weight of the head-mounted electronic device, and increase application scenes of the head-mounted electronic device in the field of unmanned aerial vehicle control.

### BRIEF DESCRIPTION OF THE DRAWINGS

The preferred embodiment of the present invention is described in detail with the accompanying drawings, and other features, objects and advantages of the present invention will become more apparent. In the accompanying drawings, the same or similar reference character represents the same or similar feature.

FIG. 1 is a sketch view of an application scene of a control system for an unmanned aerial vehicle according to a preferred embodiment of the present invention.

FIG. 2 is a flow chart of a control method for the unmanned aerial vehicle according to the preferred embodiment of the present invention.

FIG. 3 is a flow chart of a step of S204 shown in FIG. 2.

FIG. 4 is a sketch view of a control device for the unmanned aerial vehicle according to the preferred embodiment of the present invention.

FIG. 5 is a sketch view of a hardware architecture of a computing device according to the preferred embodiment of the present invention, wherein the computing device is able to realize the control method, the control device and the control system for the unmanned aerial vehicle.

### DETAILED DESCRIPTION OF THE PREFERRED EMBODIMENT

The preferred embodiment of the present invention is described more comprehensively with the accompanying drawings. The preferred embodiment can be implemented in various ways, and it should not be understood that the present invention is limited to the described preferred embodiment. The preferred embodiment is provided for completing the present invention and conveying the conception thereof more comprehensively to one skilled in the art. In the accompanying drawings, for clarity, the thickness of area and layer may be overstated. The same reference character in the accompanying drawings represents the same or similar structure, and thus the detailed description thereof is omitted.

Moreover, the described features, structures and characteristics can be combined in one or more embodiments in various ways. In the following description, many details are provided, so that the preferred embodiment of the present invention can be fully understood. However, one skilled in the art may be aware that the technical solutions of the present invention can be implemented with omitting one or more specific features or adopting other methods, components and materials. In other conditions, the common structure, material and operation are not showed and described in detail, so as to avoid a misunderstanding of the main technical idea of the present invention.

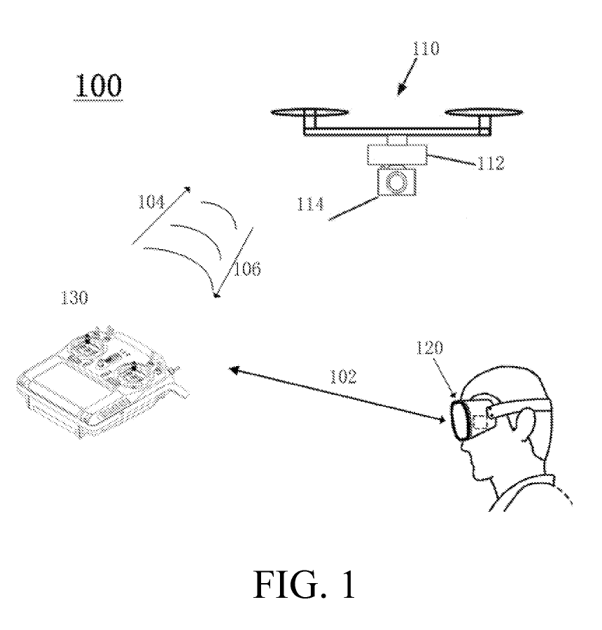

FIG. 1 is a sketch view of an application scene of a control system 100 for an unmanned aerial vehicle provided by the preferred embodiment of the present invention. The application scene can take place indoors (such as in the market, restaurant, hospital, school, station, factory and bank), and can also take place outdoors (such as at the plaza, sports ground and park). The objects for controlling the unmanned aerial vehicle are various. For example, the unmanned aerial vehicle can be applied in aerial photographing, geographic detection, virtual flight experience, detection, and rescue.

As shown in FIG. 1, the control system 100 for the unmanned aerial vehicle comprises an unmanned aerial vehicle 110. A carrying object can be carried on the unmanned aerial vehicle 110. The carrying object comprises a carrier device 112 and a bearing object 114 carried by the carrier device. The carrier device 112 can be a support for coupling the bearing object 114 with the unmanned aerial vehicle. The carrier device (or the support) 112 carrying the bearing object 114 is also called “gimbal”. The carrier device 112 can fix the bearing object and arbitrarily adjust a condition of the bearing object. The condition comprises a position (such as a height and a horizontal position), an attitude (such as pitching, left-tilting, right-tilting, left-pointing and right-pointing), a motion (such as a horizontal translation, a rotation and a lifting motion), and an accelerated speed. For example, through controlling a condition of the carrier device, the bearing object is stably kept at a certain state (such as at a certain height, horizontal position, inclination angle, direction and speed).

The carrier device 112 can serve as an auxiliary device of photographing, monitoring and sampling. The bearing object 114 can be a photographic device such as a camera and an infrared imager, and can also be a sensor. The bearing object 114 is embodied as a camera, as shown in FIG. 1, and is coupled with the unmanned aerial vehicle through the carrier device 112. Certainly, it is understandable that the bearing object can be the camera of other types, such as a surveillance camera and a floodlight.

The control system 100 for the unmanned aerial vehicle provided by the preferred embodiment further comprises a head-mounted electronic device 120 and a remote control device 130. The head-mounted electronic device 120 can be virtual reality (VR) glasses, a head-mounted VR display device, a first person view (FPV) device and a VR headset. The head-mounted electronic device 120 can comprise a sensor component of any type, such as a gyroscope, an accelerometer, an angular velocity meter, a magnetic sensor, a barometer and a thermometer. The remote control device 130 can be a single device having a transceiver module which is able to support various communication protocols. According to the preferred embodiment, the head-mounted electronic device 120 does not directly communicate with the unmanned aerial vehicle 110, but establishes a wired or wireless communication channel 102 with the remote control device 130. For example, the head-mounted electronic device establishes one or multiple wired or wireless communication channels with the remote control device through the communication protocol such as a high definition multimedia interface (HDMI), a wireless high definition multimedia interface (WHDMI), a universal serial bus (USB), Bluetooth®, WIFI® and an ultra-wide band (UWB). The remote control device 130 can be applied in the overall control of the unmanned aerial vehicle 110, such as the flight control. The remote control device 130 can sends a control instruction to the unmanned aerial vehicle 110 through a control (up) channel 104, so as to control the unmanned aerial vehicle 110 to complete various flight actions, such as taking off, rising, pitching, left-tilting and right-tilting. The remote control device 130 can also receive feedback data from the unmanned aerial vehicle 110 through a feedback (down) channel 106. The feedback data from the unmanned aerial vehicle 110 comprises an image or video data captured by the camera 114 carried on the unmanned aerial vehicle 110, condition data of every component of the unmanned aerial vehicle 110 and sensor data from various sensors mounted on the unmanned aerial vehicle 110.

The user can control the unmanned aerial vehicle 110 through the head-mounted electronic device 120. For example, through the rotation or attitude of the head or neck, an angle of the carrier device 112 (namely the gimbal) is adjusted, so that a view direction of the camera is adjusted. The image captured by the camera can return back to a display screen of the head-mounted electronic device 120 in real-time. For example, when the carrier device 112 is a three-axis carrier (namely a three-axis gimbal), the rotation of the head or neck of the user in every direction corresponds to the rotation of the gimbal in directions of three axes.

For example, a head action of the user can be measured by the sensor (such as the gyroscope, the accelerometer and the magnetic sensor) mounted in the head-mounted electronic device 120; then the sensor sends the obtained sensor data (such as attitude information about a head movement) to the remote control device 130 through the communication channel 102; after the remote control device 130 receives the sensor data, the attitude data of the head of the user is obtained through being processed with an attitude data fusion algorithm and then is converted into a recognizable control instruction of the unmanned aerial vehicle 110 (such as a gimbal control instruction); the remote control device 130 sends the control instruction to the unmanned aerial vehicle through the control channel 104; after the unmanned aerial vehicle 110 receives the control instruction, the carrier device 112 (namely the gimbal) is controlled to rotate with a corresponding angle, so as to cooperate with the head movement of the user in real-time; thereafter, the unmanned aerial vehicle 110 sends image data which is obtained after rotating the carrier device 112 to the remote control device 130 through the feedback channel 106; the remote control device 130 sends the received image data to the head-mounted electronic device 120; and after processing, the real-time feedback image of the unmanned aerial vehicle 110 can be viewed on the display screen of the head-mounted electronic device 120.

According to the preferred embodiment of the present invention, through a communication mechanism formed by the head-mounted electronic device 120, the remote control device 130 and the unmanned aerial vehicle 110, the problem that most of the conventional VR devices in the market do not have the enough communication distance when communicating with the unmanned aerial vehicle is solved. The VR display device generally communicates with the unmanned aerial vehicle through the medium-short distance communication mechanism such as the WIFI® and the Bluetooth®, which greatly limits the application scene of the combination of the VR display device and the unmanned aerial vehicle. Moreover, if the VR device directly communicates with the unmanned aerial vehicle through the medium-short distance communication mechanism, the VR device will have the problems of increased volume and weight, increased cost and increased battery consumption, which brings the inconvenience to the user.

The control system 100 for the unmanned aerial vehicle provided by the preferred embodiment of the present invention solves the above problem through an indirect communication between the head-mounted electronic device 120 and the unmanned aerial vehicle 110 with the remote control device. Firstly, the communication between the head-mounted electronic device 120 and the remote control device 130 is realized through the medium-short distance communication protocol such as the Bluetooth® and the WIFI®, or completely through the wired form. Moreover, the head-mounted electronic device 120 sends the data captured by the sensor to the remote control device 130 with merely simple processing or without any processing, so that the head-mounted electronic device 120 is merely required to have the basic communication component. The processing of the captured sensor data of the head-mounted electronic device 120 and the image data from the unmanned aerial vehicle 110, such as compressing, decoding and deciphering, can be completely realized by the remote control device 130, in such a manner that the cost, weight, volume and battery consumption of the head-mounted electronic device 120 are greatly decreased. The remote control device 130 generally has the medium-long distance communication capability with the unmanned aerial vehicle 110 and the communication component, and the additional function does not greatly increase the cost of the remote control device 130. According to actual experimental results, the control system for the unmanned aerial vehicle provided by the preferred embodiment is able to increase an effective communication distance between the head-mounted electronic device 120 and the unmanned aerial vehicle 110 to above two kilometers, while the conventional control system merely has the effective communication distance of about 100 meters. Thus, the application scene of the VR device in the field of unmanned aerial vehicle is greatly increased.

In some cases, maybe the user has bought the conventional remote controller and the unmanned aerial vehicle, and controls the unmanned aerial vehicle through the conventional remote controller. If the user wants to use a head-mounted electronic device or VR display device, maybe the user not only needs to buy the head-mounted electronic device or the VR display device, but also needs to buy a new remote control device which supports the communication with the head-mounted electronic device or the VR display device, because the owned conventional remote controller may not support the communication with the head-mounted electronic device or the VR display device, which causes the idleness and waste of the device resources. The above problem can be solved by the remote control device 130 shown in FIG. 1, wherein the remote control device comprises two discrete devices. The first discrete device is embodied as the conventional remote controller, and the second discrete device is embodied as an additional communication processing device (such as an android box). The communication processing device supports the communication with the head-mounted electronic device and the remote controller at the same time, and has the computing capability. According to the preferred embodiment, the sensor data obtained by the head-mounted electronic device 120 can be sent to the communication processing device through the established communication channel; the communication processing device receives the original sensor data from the head-mounted electronic device 120, obtains the real-time attitude data of the head or neck of the user through the attitude data fusion algorithm, and then converts the real-time attitude data into the recognizable control instruction of the unmanned aerial vehicle; the communication processing device sends the generated control instruction to the remote controller through the communication channel established with the remote controller; and finally, the remote controller sends the control instruction to the unmanned aerial vehicle 110 through the transceiver module. During the process of receiving the image data returned from the unmanned aerial vehicle 110, the unmanned aerial vehicle 110 firstly sends the image data to the remote controller through the medium-long distance communication protocol; then the remote controller transmits the image data to the communication processing device; the communication processing device processes the received image data from the unmanned aerial vehicle 110 with coding and decoding, or any other suitable treatment, and sends the processed image data to the head-mounted electronic device 120. Thus, the additional communication capability and computing capability which are required due to the addition of the head-mounted electronic device 120 can be realized through the additional communication processing device, in such a manner that the head-mounted electronic device 120 merely needs the simple signal transceiver module and the basic display module; and the additional communication processing device is responsible for completing the complex functions such as the complex communication protocol establishment, the attitude data fusion processing, and coding and decoding. The communication processing device can process the real-time image data transmitted by the remote controller with the split screen treatment, so that the image displayed on the display screen of the head-mounted electronic device 120 will be more real.

One skilled in the art should understand that: components which are shown in FIG. 1 (such as the unmanned aerial vehicle 110, the head-mounted electronic device 120 and the remote control device 130) are exemplary only and not for limiting the protection range of the present invention. The unmanned aerial vehicle 110 can be the two-rotor unmanned aerial vehicle shown in FIG. 1, and can also be the unmanned aerial vehicle with four rotors or six rotors; the head-mounted electronic device 120 can be the VR glasses shown in FIG. 1, and can also be the head-mounted electronic device of other forms; and the remote control device 130 is not limited to the specific structure shown in FIG. 1.

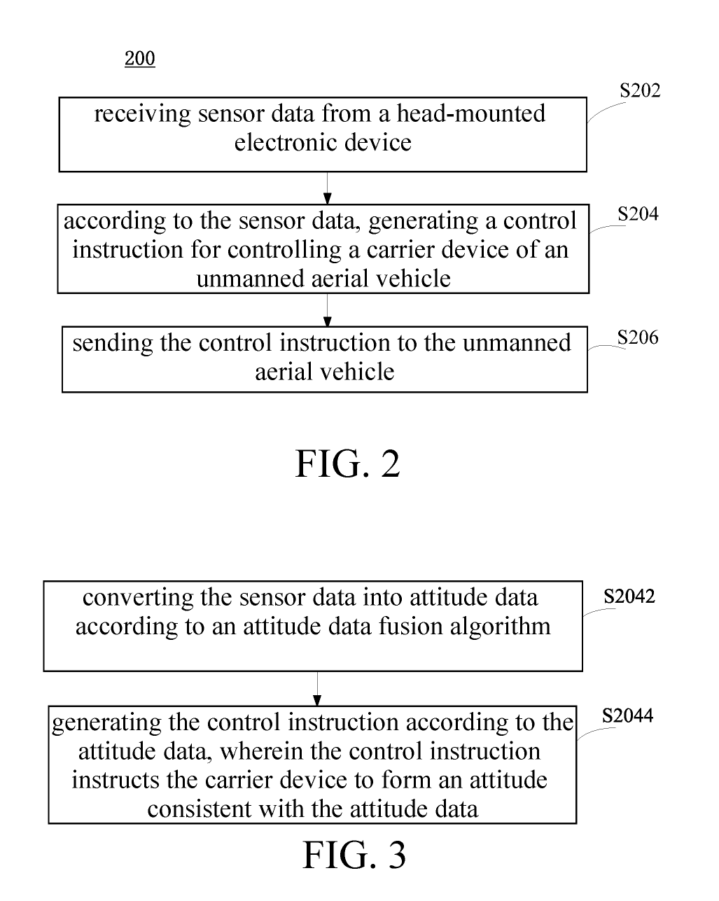

FIG. 2 is a flow chart of a control method 200 for an unmanned aerial vehicle provided by the preferred embodiment of the present invention. As shown in FIG. 2, the control method 200 comprises steps of: S202, receiving sensor data from a head-mounted electronic device; S204, according to the sensor data, generating a control instruction for controlling a carrier device of the unmanned aerial vehicle; and S206, sending the control instruction to the unmanned aerial vehicle.

The head-mounted electronic device can be the head-mounted electronic device 120 shown in FIG. 1; the unmanned aerial vehicle can be the unmanned aerial vehicle 110 shown in FIG. 1; and the control method can be executed by the remote control device 130 which is for controlling the unmanned aerial vehicle. The control instruction generated by the remote control device 130 can control the actions of the carrier device 112 of the unmanned aerial vehicle 110 in the directions of pitching, yawing and side-turning, and can also control the horizontal movement of the carrier device 112 in every direction. The sensor data from the head-mounted electronic device 120 can be data generated by any sensor component (such as the gyroscope, the accelerometer, the magnetic sensor, the angular velocity meter and the barometer). The sensor data can also be related to the user condition of the head-mounted electronic device 120. The sensor data can reflect the movement condition of the head or neck of the user. For example, when the head of the user rotates upwards or rightwards, the sensor in the head-mounted electronic device 120 can sense the corresponding sensor data. The remote control device 130 can generate the control instruction according to the received sensor data, for controlling the carrier device of the unmanned aerial vehicle 110 to act correspondingly with the head movement of the user, so that the vision angle of the camera carried by the carrier device 112 changes correspondingly with the head movement of the user, which brings the more real flight experience effect to the user.

As shown in FIG. 3, the step of S204 shown in FIG. 2 further comprises steps of: S2042, according to an attitude data fusion algorithm, converting the sensor data into attitude data; and S2044, generating the control instruction according to the attitude data, wherein the control instruction instructs the carrier device to form an attitude consistent with the attitude data.

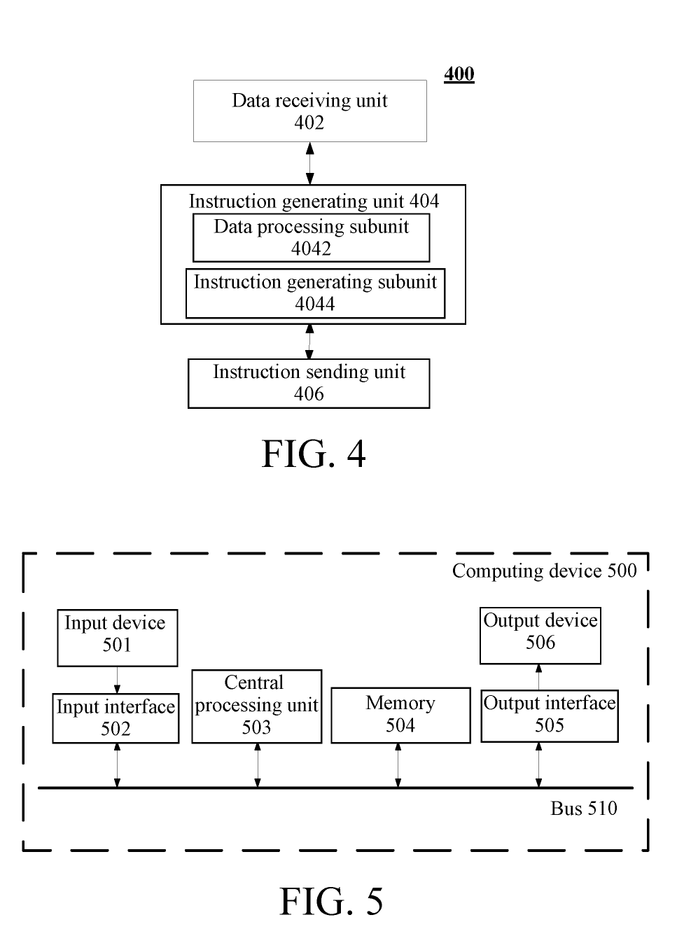

The control method for the unmanned aerial vehicle is described in detail with FIGS. 1-3, and the control device 400 for the unmanned aerial vehicle is described as follows with FIG. 4.

As shown in FIG. 4, the control device 400 for the unmanned aerial vehicle provided by the preferred embodiment of the present invention comprises a data receiving unit 402, an instruction generating unit 404 and an instruction sending unit 406. The data receiving unit 402 is for receiving sensor data from a head-mounted electronic device; the instruction generating unit 404 is for generating a control instruction for controlling a carrier device of the unmanned aerial vehicle according to the sensor data; and the instruction sending unit 406 is for sending the control instruction to the unmanned aerial vehicle.

The instruction generating unit 404 further comprises a data processing subunit 4042 and an instruction generating subunit 4044, wherein: the data processing subunit 4042 is for converting the sensor data into attitude data according to an attitude data fusion algorithm; and the instruction generating subunit 4044 is for generating the control instruction according to the attitude data, wherein the control instruction instructs the carrier device to form an attitude consistent with the attitude data.

Other details of the control device for the unmanned aerial vehicle are the same as that of the control method described with FIGS. 1-3 and not repeated again.

The control device for the unmanned aerial vehicle provided by the preferred embodiment is able to increase a communication distance between the head-mounted electronic device and the unmanned aerial vehicle, decrease a cost and a weight of the head-mounted electronic device, and increase application scenes of the head-mounted electronic device in the field of unmanned aerial vehicle control.

The control system for the unmanned aerial vehicle provided by the preferred embodiment comprises the head-mounted electronic device, the remote control device and the unmanned aerial vehicle. The head-mounted electronic device sends the generated sensor data to the remote control device; the remote control device generates the control instruction for controlling the carrier device of the unmanned aerial vehicle according to the received sensor data and sends the control instruction to the unmanned aerial vehicle; and, according to the received control instruction, the unmanned aerial vehicle adjusts the carrier device to form an attitude corresponding to the control instruction. Furthermore, the remote control device converts the sensor data into the attitude data through the attitude data fusion algorithm and then generates the control instruction according to the attitude data.

Other details of the control system for the unmanned aerial vehicle can refer to the above detailed description of the control system shown in FIG. 1 and are not repeated again.

At least a part of the control method, the control device and the control system for the unmanned aerial vehicle shown in FIGS. 1-4 can be realized by a computing device. FIG. 5 is a sketch view of a hardware architecture of the computing device, wherein the computing device is able to realize the control method, the control device and the control system for the unmanned aerial vehicle provided by the preferred embodiment. As shown in FIG. 5, the computing device 500 comprises an input device 501, an input interface 502, a central processing unit 503, a memory 504, an output interface, and an output device 506, wherein: the input interface 502, the central processing unit 503, the memory 504 and the output interface 505 are connected with each other through a bus 510; and, the input device 501 and the output device 506 are connected with the bus 510 respectively through the input interface 502 and the output interface 505, so as to connect with other components of the computing device 500. The input device 501 receives input information from an exterior of the computing device and sends the input information to the central processing unit 503 through the input interface 502; the central processing unit 503 processes the input information based on a computer executable instruction stored in the memory 504 and generates output information, then stores the output information temporarily or permanently in the memory 504, and transmits the output information to the output device 506 through the output interface 505; and, the output device 506 outputs the output information to the exterior of the computing device 500 for the users.

That is to say, it is feasible that the device shown in FIG. 4 comprises a memory in which a computer executable instruction is stored and a processer, wherein the processer can realize the control method for the unmanned aerial vehicle described with FIGS. 1-3 when executing the computer executable instruction. The processer executes the computer executable instruction based on the input information, so as to realize the control method for the unmanned aerial vehicle which is described with FIGS. 1-3.

It is noted that the present invention is not limited to the specific configuration and implementation which are described above and shown in figures. For brief description, the detailed description about the conventional methods is omitted. In the above preferred embodiment, the specific steps are described and showed as an example. However, the process of the method provided by the present invention is not limited to the above described and showed specific steps. One skilled in the art can make various changes, modifications and additions, or change a sequence of the steps based on the spirit of the present invention.

The functional modules shown in the sketch views can be the hardware, software, firmware or the combination thereof. When being realized by means of hardware, the modules can be the electronic circuit, application specific integrated circuit (ASIC), appropriate firmware, plug-in, function card and so on. When being realized by means of software, the elements of the present invention can be the program or code segment for executing the required task. The program or the code segment can be stored in the machine-readable medium or be transmitted in the transmission medium or the communication link through the data signal in the carrier wave. The machine-readable medium comprises every medium can store or transmit the information. For example, the machine-readable medium can be the electronic circuit, semiconductor memory device, read-only memory (ROM), flash memory, erasable read-only memory (EROM), soft disk, CD-ROM, light disk, hard disk, fiber medium, and radio frequency (RF) link. The code segment can be downloaded from the computer network such as the Internet and Intranet.

The present invention can be realized in other forms without departing from the spirit and substantive characteristics of the present invention. For example, the algorithm described in the preferred embodiment can be modified, while the system architecture is not departing from the basic spirit of the present invention. Thus, the preferred embodiment is exemplary only and not for limiting the present invention. The protection range of the present invention is defined by the following claims, not by the above description. Moreover, all modifications encompassed in the range of the definition and equivalents of the claims are included in the protection range of the present invention.

What is claimed is:

1. A control method for an unmanned aerial vehicle, comprising steps of:
receiving sensor data from a head-mounted electronic device;
according to the sensor data, generating a control instruction for controlling a carrier device of the unmanned aerial vehicle; and
sending the control instruction to the unmanned aerial vehicle.

2. The control method, as recited in claim 1, wherein the step of “according to the sensor data, generating a control instruction for controlling a carrier device of the unmanned aerial vehicle” further comprises steps of:
converting the sensor data into attitude data according to an attitude data fusion algorithm; and
generating the control instruction according to the attitude data, wherein the control instruction instructs the carrier device to form an attitude consistent with the attitude data.

3. The control method, as recited in claim 1, wherein the control instruction controls actions of the carrier device of the unmanned aerial vehicle in directions of pitching, yawing and side-turning.

4. The control method, as recited in claim 1, wherein the sensor data comprises data generated by a gyroscope, an accelerometer or a magnetic sensor in the head-mounted electronic device and data related to a condition of a user of the head-mounted electronic device.

5. The control method, as recited in claim 1, wherein the head-mounted electronic device comprises virtual reality (VR) glasses and a VR headset.

6. The control method, as recited in claim 1, wherein the sensor data is received through a wired channel.

7. A control device for an unmanned aerial vehicle, comprising:
a data receiving unit, for receiving sensor data from a head-mounted electronic device;
an instruction generating unit, for generating a control instruction for controlling a carrier device of the unmanned aerial vehicle according to the sensor data; and
an instruction sending unit, for sending the control instruction to the unmanned aerial vehicle.

8. The control device, as recited in claim 7, wherein the instruction generating unit further comprises:
a data processing subunit, for converting the sensor data into attitude data according to an attitude data fusion algorithm; and
an instruction generating subunit, for generating the control instruction according to the attitude data, wherein the control instruction instructs the carrier device to form an attitude consistent with the attitude data.

9. The control device, as recited in claim 7, wherein the control instruction controls actions of the carrier device of the unmanned aerial vehicle in directions of pitching, yawing and side-turning.

10. The control device, as recited in claim 7, wherein the sensor data comprises data generated by a gyroscope, an accelerometer or a magnetic sensor in the head-mounted electronic device and data related to a condition of a user of the head-mounted electronic device.

11. The control device, as recited in claim 7, wherein the head-mounted electronic device comprises VR glasses and a VR headset.

12. The control device, as recited in claim 7, wherein the sensor data is received through a wired channel.

13. The control device, as recited in claim 7, wherein the control device is applied in a remote control device for controlling the unmanned aerial vehicle.

14. A control system for an unmanned aerial vehicle, comprising a head-mounted electronic device, a remote control device and the unmanned aerial vehicle, wherein:
the head-mounted electronic device sends generated sensor data to the remote control device;
the remote control generates a control instruction for controlling a carrier device of the unmanned aerial vehicle according to the received sensor data, and sends the control instruction to the unmanned aerial vehicle; and
the unmanned aerial vehicle adjusts the carrier device according to the received control instruction to form an attitude corresponding to the control instruction.

15. The control system, as recited in claim 14, wherein the remote control device converts the sensor data into attitude data through an attitude data fusion algorithm and generates the control instruction according to the attitude data.

16. The control system, as recited in claim 14, wherein the control instruction controls actions of the carrier device of the unmanned aerial vehicle in directions of pitching, yawing and side-turning.

17. The control system, as recited in claim 14, wherein the sensor data comprises data generated by a gyroscope, an accelerometer or a magnetic sensor in the head-mounted electronic device and data related to a condition of a user of the head-mounted electronic device.

18. The control system, as recited in claim 14, wherein the head-mounted electronic device comprises VR glasses and a VR headset.

19. The control system, as recited in claim 14, wherein the sensor data is received through a wired channel.
